(19) United States
(12) Patent Application Publication
(10) Pub. No.: US 2010/0153265 A1
(43) Pub. Date: Jun. 17, 2010

(54) SINGLE PAGE ON-LINE CHECK-OUT

(75) Inventors: David Mark Hershfield, San Jose, CA (US); Donald J. Fotsch, Palo Alto, CA (US)

Correspondence Address: Haynes and Boone, LLP;IP Section, 2323 Victory Avenue, SUITE 700, Dallas, TX, 75219, US

(73) Assignee: eBay Inc., San Jose, CA (US)

(21) Appl. No.: 12/335,314

(22) Filed: Dec. 15, 2008

(51) Int. Cl. G06F 3/048; G06Q 30/00; G06Q 20/00

(52) U.S. Cl. 705/40; 715/825

(57) ABSTRACT

A single page on-line checkout includes a dynamically changing visual receipt and options for both payment and shipping. In one embodiment, the visual receipt enables the user to select an item on the visual receipt for display as a visual representation on the visual receipt. The screen refreshes to show an updated visual receipt when a payment or shipping option is selected. Additional payment or shipping options can be easily added and shown on the checkout page or screen.

### BACKGROUND

1. Field of the Invention

The present invention generally relates to on-line financial transactions and more particularly to completing such transactions on-line.

2. Related Art

In on-line financial transactions, customers search for and purchase products and services through electronic communications with on-line merchants over electronic networks, such as the Internet. During the course of these transactions, customers may provide payment in various ways including, for example, credit cards, electronic fund transfers, and other payment techniques offered by on-line payment providers.

Typically, when shopping on-line at a particular website, customers select items to purchase by clicking on a link for a specific item, and the selected items are placed on reserve in some type of virtual shopping cart. When done shopping, the customer proceeds to a separate checkout page to provide payment for the selected items. The checkout page includes various fields for the customer to fill in for payment of the items. For example, fields may include name of the customer, account information about the payment source, billing address, and shipping address. Account information may include selecting a type of payment source, such as a specific type of credit card, bank card, or on-line payment provider like PayPal, Inc., and entering an account number and a security code or routing number. Because these fields may occupy a large portion of the customer's viewing area, there may be little or no space for a description of the customer's selected items for purchase. If the customer wants to review the items with a more detailed description, the customer may need to go back to an item description page and possibly lose the information entered on the checkout page. At a minimum, this can be tedious and inconvenient because the customer might need to toggle back and forth between multiple on-line pages or screens. This may lead to the potential customer cancelling or abandoning the transaction, resulting in loss sales for the merchant.

### SUMMARY

Embodiments of the present disclosure provide a single page check-out for on-line purchases. In one embodiment, a customer is shown a screen having a visual receipt of the items being purchased, funding or payment options, and shipping options. The visual receipt has a list of the items, along with price, quantity, and total cost for each item. In one embodiment, by selecting an item, such as by clicking on or moving a mouse over the item description on the visual receipt, a picture or other visual representation of the item is shown at the top of the visual receipt. The visual receipt also shows the funding source or sources and who the items are to be shipped to. In one embodiment, individual items in the visual receipt can be paid by different funding sources and/or shipped to different addresses. On the same page, the customer can be shown multiple funding sources or payment methods and multiple shipping addresses. This can be shown as a written description or as an icon. The customer can simply click on a desired funding source and shipping address, either for all the items in the visual receipt or for selected items. Once the funding source or shipping address is selected, the visual receipt changes to reflect the choices.

According to one embodiment, the customer starts the on-line shopping process by first accessing the on-line site of a retailer or seller. The customer selects items from the site, such as by clicking on the item or an icon, which places selected items into a virtual shopping basket or cart. When the customer is finished shopping and wants to check-out or pay for the items, the customer may clink on a link to a payment provider, such as PayPal, Inc. of San Jose, or click on a “Submit/Continue” type of link. The customer is then presented with a page showing the visual receipt. The receipt shows, among other things, the list of items, price, quantity, totals, shipping option and cost, and tax. Also on the screen, the customer is shown fields to log into the customer's account of the payment provider. This may include the customer's email address or user name and the password for the account. Once accessed, the screen still shows the visual receipt, but also shows one or more payment options and one or more shipping addresses. In one embodiment, the visual receipt includes a tag that enables the customer to return to the on-line retailer site or a tag to pay with funds from a customer account of the payment provider.

The customer can then click on a payment option, such as one or more checking accounts, one or more credit card accounts, or one or more payment provider accounts. The visual receipt is then immediately updated to show the selected payment option. The customer can also click on a shipping address option, such as the customer's home or work address or one or more relative's home or work address. Once selected, the visual receipt is again immediately updated to show the shipping address. Selection of the payment option and shipping address can be performed in any order. In one embodiment, the payment source and/or the shipping address can be different for different items in the receipt, thereby allowing the customer to send different items to different recipients and for different items to be paid from different accounts.

When the customer is ready to finalize the payment and shipping, the customer can click on a link on the same page, such as attached to the visual receipt. This sends the payment to the on-line retailer, and the page refreshes to show the customer that the payment was sent and gives the customer a transaction ID associated with the payment. The visual receipt is also shown on the same page with links that enable the customer to print, download, or send to e-mail the receipt.

In one embodiment, the checkout page showing the visual receipt also has links that enable the customer to add a new shipping address or a new payment source. Once a link is clicked on, a screen is shown with fields for the customer to enter in order to add the new shipping address or payment source. In one embodiment, this new screen is simply overlaid over the checkout page.

As a result, customers are able to quickly and easily checkout using a single page that includes a visual receipt and easy-to-use options for selecting payment sources and shipping addresses. The customer can even add new payment sources or addresses on the same checkout page. Consequently, the customer experiences a visually appealing and simple to use checkout process on a single on-line page or screen.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing steps used to facilitate an on-line checkout according to one embodiment;

FIG. 2 is a block diagram of a system used for facilitating an on-line checkout according to one embodiment;

FIG. 3 is a block diagram of one embodiment of a system that can be used to implement one or more components of the system in FIG. 2; and

FIGS. 4A-4G are screen shots showing exemplary screen shots seen by a user during an on-line checkout process.

Exemplary embodiments and their advantages are best understood by referring to the detailed description that follows. It should be appreciated that like reference numerals are used to identify like elements illustrated in one or more of the figures, wherein showings therein are for purposes of illustrating exemplary embodiments and not for purposes of limiting the same.

### DETAILED DESCRIPTION

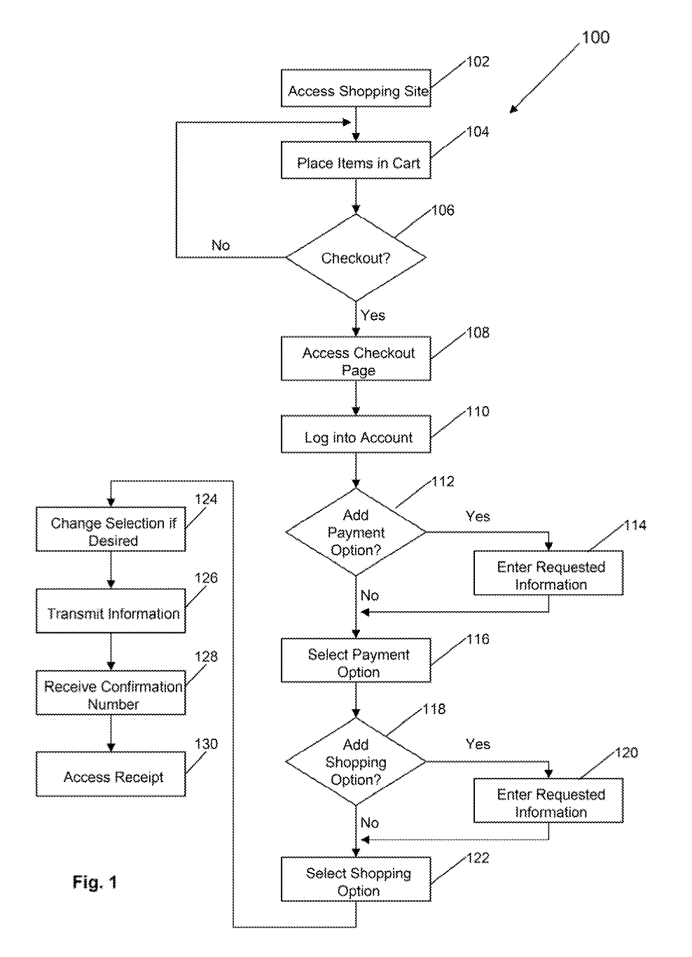

FIG. 1 is a flowchart 100 showing one embodiment of the present disclosure, which enables customers to quickly and easily finalize on-line purchases using a single checkout page. At step 102, a customer, consumer, or user first accesses an on-line shopping site on the Internet, such as through a personal computer (PC), a laptop, or a mobile device. The customer then navigates through the-site to select desired items for purchase. Typically, once an item is shown or identified, the customer is given an option of placing the item into a virtual shopping cart or basket. Desired items are then placed into the virtual shopping cart in step 104. After each item is placed in the shopping cart, the customer has the option, at step 106, of checking out (e.g., pay for the items and designate shipping) or continuing to shop. When the customer has finished shopping and is ready to check out, as determined in step 106, the customer access a checkout page of a payment provider, such as PayPal, Inc., at step 108. Accessing can be accomplished with links that the customer can click on the shopping site. Such links can appear after an item is placed in the shopping cart or may be continually visible during the shopping process. Examples of suitable links may be “Pay With PayPal,” “Continue,” “Submit,” “Checkout,” or the like.

Once the customer is taken to the checkout page, the customer sees, on a single page or screen, a visual receipt listing items for purchase and fields for the customer to log into his or her account with the payment provider. The visual receipt may also include the quantities and prices for the items, as well as a total amount and tax. In one embodiment, the visual receipt has a portion that shows a photo or visual representation of a selected item. For example, when the customer clicks on an item listed in the visual receipt or rolls the mouse over the item listing, the photo or visual representation appears at the top of the visual receipt. When the checkout appears, the customer can log into his or her account with the payment provider at step 110. Typical log in fields may include an email address or user name and a password. Once the requested information is entered, the customer clicks on a link to submit the information for verification with the payment provider. Upon verification, the customer is logged into the account and the screen refreshes showing the customer the visual receipt, along with options for payment and shipping. The options may be displayed as text, icons, or any suitable link. The visual receipt may also include an icon or tab that enables the customer to return to the on-line shopping site, such as when the customer wants to add or delete items to the receipt.

At step 112, the customer decides whether a payment option is to be added. This may be the case where the customer currently does not have any payment options or funding sources associated with the account or where the customer wants to use a different payment option than what is currently displayed. If a payment option is to be added, the customer may simply click on an “Add Account” or similar link in the checkout page. By doing so, a new page may pop up overlying the checkout page. The new page may cover only a portion of the checkout page. The customer may be presented with several sequential pages with specific fields for the customer to complete before an account is added. For example, the customer may be first asked to specify the type of account to be added, such as a bank account, a credit card account, or a debit card account. For a bank, the customer may then be asked to search for, select, or enter a bank, followed by entering specific account information, such as a routing number and an account number for a checking or savings account. For a credit or debit card, the customer may be asked to enter the name on the card, the card type (e.g., Visa, Mastercard, American Express, Discover, etc.), card number, security code, and expiration date. When the appropriate information has been entered, the desired account is added to the customer's account. The overlaid page then disappears and the single checkout page is updated with a new link showing the just-added account.

Next, the customer selects the desired payment option or funding source on the single checkout page at step 116. Selection may be simply clicking on the link or icon representing the funding source. Upon selection, the checkout page is refreshed and the visual receipt is updated to now show the payment or funding source on the receipt. Next, at step 118, the customer decides whether to add a shipping address to the account, which may be the case when the customer does not have any shipping addresses, wants to add a new address, or wants to change or update an existing address. If a shipping address is to be added, the customer may click on a link on the checkout page, which opens up a new page. The new page can overlay the checkout page and cover a portion of the checkout page. Through the page or a series of pages, the customer enters the requested information, such as name, address, city, state, country, and zip code, at step 120. The customer may also enter a nickname for the address, such as Parents, Brother Phil, Work, Home, etc. Once finished, the page disappears and the checkout page refreshes, showing the new shipping address as part of the shipping options. At step 122, the customer may select a desired shipping address, such as clicking on the appropriate icon or link. The checkout page then refreshes to now show the payment source and the shipping address for the items on the visual receipt.

Note that the selection of payment options and shipping addresses can be done in any order, as well as adding a payment option or a shipping address. Thus, steps 112-122 described above can be performed in any order, as desired by the customer or set forth by the payment provider.

In some embodiments, the customer can select different payment options or funding sources for different items from the same visual receipt. For example, clicking on a specific item on the visual receipt may give the customer an option of selecting a specific funding source for that item, such as with a drop down menu. An item may also be dragged and dropped to a specific funding source or vice versa. Having this option enables the customer to choose different accounts to pay for different items. This may be desirable if the customer does not want to use funds from a single source to pay for all the items, such as for account purposes or availability funds. Another reason may be if the customer does not want his wife to see a purchase made from an account accessible by his wife, such as for an anniversary surprise. Similarly, separate shipping addresses can be selected for different items on the visual receipt, using the same or similar methods as the selective payment options. This allows a customer to do all the shopping on one site, while still having the ability to send items to different recipients. Conventionally, if the customer wants to pay for different items using different payment options or wants to send different items to different recipients, the customer would need to create a separate shopping cart (or receipt) for each separate payment or each separate shipping address. In turn, the customer would need to go through a separate checkout process for each.

Once the payment source(s) and shipping address(es) have been selected, the customer has the ability to quickly and easily change a payment source or shipping address if desired, as step 124. The customer may simply click on a different payment source or shipping address. The visual receipt then refreshes and immediately shows the newly selected choice.

When no more changes are to be made to either the payment option or shipping address, the customer transmits the payment and shipping information to the on-line retailer at step 126. In one embodiment, the customer clicks on a tab attached to the visual receipt, where the tab indicates that the customer is ready to finalize the purchase. The tab may say “Pay” or any other suitable descriptor. Once the payment and shipping information are sent by the payment provider, the checkout screen refreshes to show the customer, at step 128, a confirmation or transaction ID number, indicating that the payment and shipping information has been successfully sent. The screen still includes the visual receipt, but now the visual receipt includes one or more tabs or icons that allow the customer to access the receipt. In one embodiment, clicking on one tab downloads the receipt to a selected destination and clicking on another tab prints the receipt from an associated printer. Thus, at step 130, the customer may access the receipt and complete the transaction.

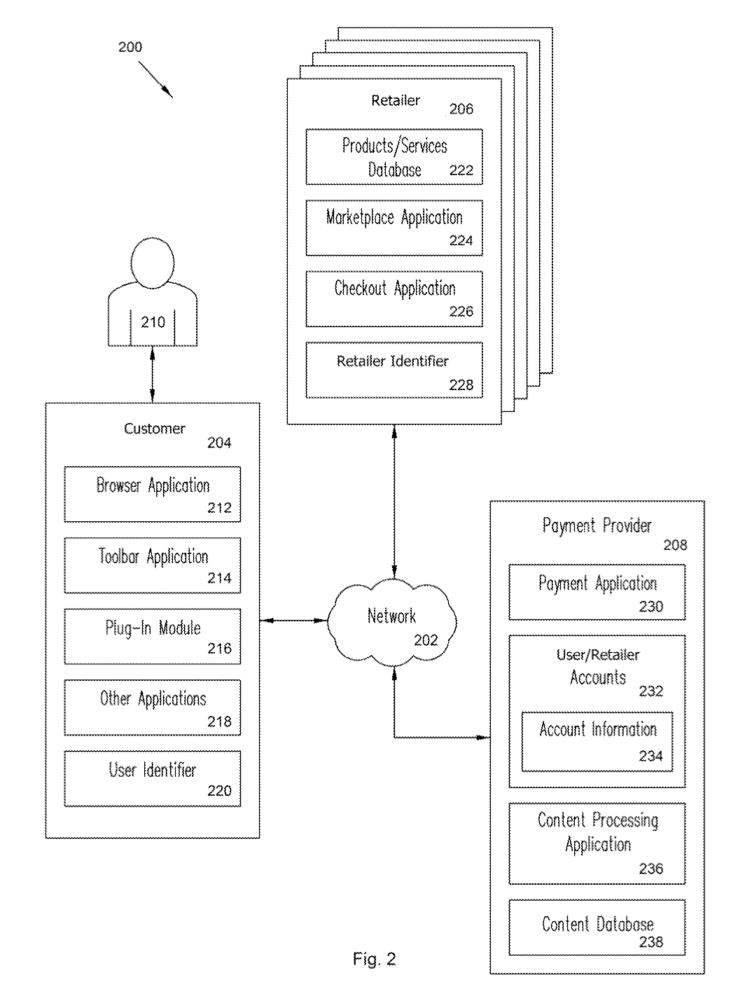

FIG. 2 shows one embodiment of a block diagram of a system 200 configured to perform transactions discussed above over a network 202. As shown in FIG. 2, system 200 includes at least one customer device 204, one or more on-line retailer servers 206, and at least one payment provider server 208 in communication over network 202. Network 202, in one embodiment, may be implemented as a single network or a combination of multiple networks. For example, in various embodiments, network 202 may include the Internet and/or one or more intranets, landline networks, wireless networks, or a wireless telecommunications network (e.g., cellular phone network) adapted to communicate with other communication networks, such as the Internet.

Customer device 204 may be implemented using any appropriate combination of hardware and/or software configured for wired and/or wireless communication over network 202. For example, customer device 204 may be implemented as a personal computer, mobile device such as a cell phone, or a laptop of a customer or user 210 in communication with network 202. Customer device 204 may include one or more browser applications 212 which may be used, for example, to provide a user interface to permit user 210 to browse information available over network 202. For example, browser application 212 may be implemented as a web browser to view information available over the Internet.

Customer device 204 may include one or more toolbar applications 214, which may be used, for example, to provide client-side processing for performing tasks in response to operations selected by user 210. For example, toolbar application 214 may display a graphical user interface (GUI) in connection with browser application 212. Customer device 204 may also include a plug-in module 216 for facilitating financial transactions over network 202. In one implementation, plug-in module 216 comprises a software program, such as a graphical user interface (GUI), executable by a processor that is configured to interface and communicate with the one or more retailer servers 206 and the payment provider server 208 via network 202. User 210 is able to access on-line retailer sites via retailer servers 206 to view and select items for purchase, and user 210 is able to purchase selected items from the one or more retailers by communicating with the payment provider server 208 via a network browser, such as a web browser.

Customer device 204 may include other applications 218 as may be desired in particular embodiments to provide additional features available to user 210. For example, such other applications 218 may include security applications for implementing customer-side security features, programmatic customer applications for interfacing with appropriate application programming interfaces (APIs) over network 202 or various other types of generally known programs and/or applications.

Customer device 204 may include one or more user identifiers 220, which may be implemented, for example, as operating system registry entries, cookies associated with browser application 212, identifiers associated with hardware of customer device 204, or various other appropriate identifiers. User identifier 220 may include attributes related to the user, such as personal information (e.g., a user name, password, photograph image, biometric id, address, phone number, etc.) and banking information (e.g., banking institution, credit card issuer, user account numbers, security information, etc.). In various implementations, user identifier 220 may be passed with a user purchase request to payment provider server 208, and user identifier 220 may be used by payment provider server 208 to associate user 210 with a particular user account maintained by payment provider server 208.

The one or more retailer servers 206 may be maintained, for example, by one or more retailers offering various items, such as products and/or services, in exchange for financial payment to be received from users, such as user 210, over network 202. In this regard, each of the one or more retailer servers 206 may include a database 222 for identifying available products and/or services, which may be made available to customer device 204 for viewing and purchase by user 210. Accordingly, each of retailer servers 206 may include a marketplace application 224, which may be configured to provide information over network 202 to browser application 212 of customer device 204. For example, user 210 may interact with marketplace application 224 through browser application 212 over network 202 to search and view various items, products and/or services identified in database 222.

Retailer server 206 may include a checkout application 226, which may be configured to facilitate online purchase transactions by user 210 of products and/or services identified by marketplace application 224. In this regard, checkout application 226 may be configured to accept payment information from user 210 and/or from payment provider server 208 over network 202. Retailer server 206 may also include one or more retailer identifiers 228, which may be included as part of the one or more items made available for purchase so that particular items are associated with particular retailers. Retailer identifier 228 may include attributes related to the retailer, such as business and banking information. In various implementations, retailer identifier 228 may be passed with a user purchase request to payment provider server 208 when user 210 selects an item for purchase, and retailer identifier 228 may be used by payment provider server 208 to associate a particular item purchased with a particular retailer account maintained by payment provider server 208.

Retailers having a related retail server 206 may need to establish a retailer account with payment provider server 208 so that payment server provider 208 is able to process transactions having items offered for purchase by the retailers. When establishing a retailer account, the retailer may need to provide business information, such as name, address, phone number, etc., and financial information, such as banking information, merchant account information, credit card information, payment processing information, etc. Retailer server 206 may be associated with a particular link (e.g., a link, such as a URL (Uniform Resource Locator) to an IP (Internet Protocol) address). In this regard, payment provider server 208 may optionally redirect browser application 212 to an appropriate web page and/or retailer site of retailer server 206 to facilitate purchase of a corresponding item and/or service available from retailer server 206.

Payment provider server 208 may be maintained, for example, by an online payment service provider, which may provide payment processing for online transactions on behalf of user 210 to an operator of retailer server 206. Payment provider server 208 may include one or more payment applications 230, which may be configured to interact with customer device 204 and/or each of retailer servers 206 over network 202 to facilitate the purchase of items, products and/or services by user 210 from retailer server 206. In one example, payment provider server 208 is provided by PayPal, Inc.

Payment provider server 208 may be configured to maintain a plurality of user and retailer accounts 232, each of which may include account information 234 associated with individual users, including user 210, and the one or more on-line retailers associated with retailer servers 206. For example, account information 234 may include private financial information of user 210 and retailers, such as one or more account numbers, passwords, credit card information, banking information, or other types of financial information, which may be used to facilitate online transactions between user 210 of the customer device 204 and one or more retailers associated with retailer servers 206. As such, payment application 230 may be configured to interact with the one or more retailer servers 206 on behalf of user 210 during a transaction with checkout application 226 without requiring user 210 to provide account information 234 directly to retailer server 206. Payment provider server 208 may also include a content processing application 236, which may select content from a content database 238 to be provided to user 102. Content processing application 236 may provide appropriate rules-based or heuristics-based facilities for selecting appropriate content for user 102 based on, for example, user identifier 220, user account 232, user account information 234, information received from retailer server 206, or other characteristics

Payment provider server 208, through payment application 230, user/retailer accounts 232, content processing application 236, and content database 238, may provide the single page, on-line checkout, as described above. For example, payment provider server 208, based on communication with retailer server 206 and customer device 204, configures a check-out screen that is displayed to user 210 on customer device 204. Then, based on information entered by user 210 via customer device 204, payment provider server 208 communicates information, such as shipping information, to retailer server 206, and processes information, such as payment information, to effect a transfer of funds to a suitable retailer account 232.

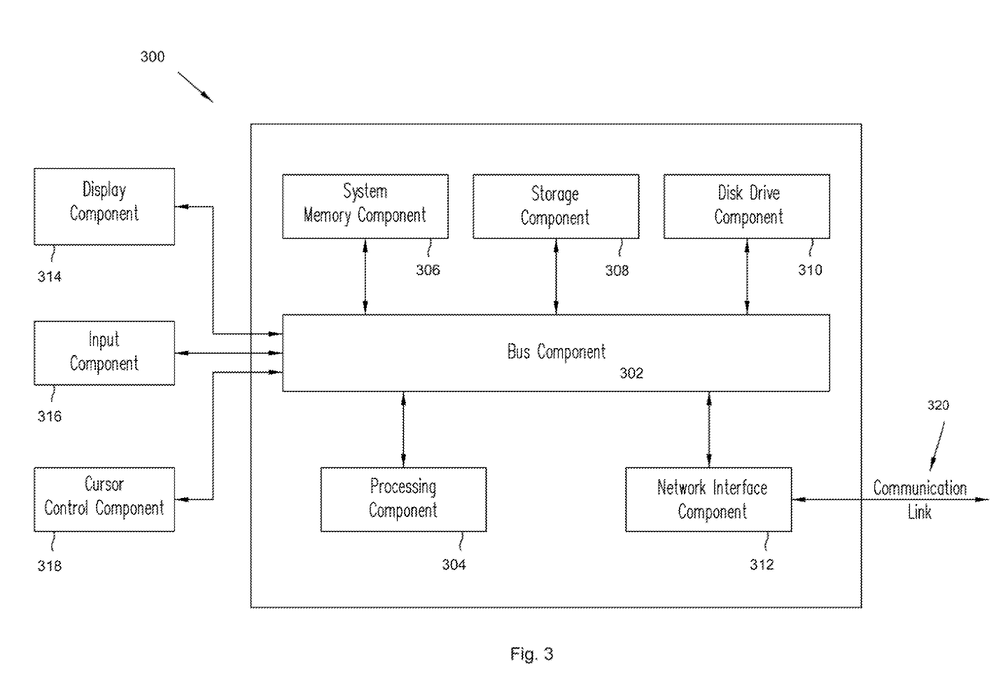

FIG. 3 is a block diagram of a computer system 300 according to one embodiment, which may be suitable for implementing embodiments of various aspects of this disclosure, including, for example, user device 204, retailer server 206 and/or payment provider server 208. In various implementations of various embodiments, user device 204 may comprise a personal computing device, such as a personal computer, laptop, PDA, cellular phone or other personal computing or communications devices. Retailer server 206 and/or payment provider server 208 may comprise a network computing device, such as one or more servers, computer or processor combined to provide the payment services. Thus, it should be appreciated that user device 204, retailer server 206, and/or payment provider server 208 may be implemented as computer system 300 in a manner as follows.

In one embodiment, computer system 300 may include a bus 302 or other communication mechanism for communicating information, which interconnects subsystems and components, such as a processing component 304 (e.g., processor, micro-controller, digital signal processor (DSP), etc.), a system memory component 306 (e.g., RAM), a static storage component 308 (e.g., ROM), a disk drive component 310 (e.g., magnetic or optical), a network interface component 312 (e.g., modem or Ethernet card), a display component 314 (e.g., CRT or LCD), an input component 316 (e.g., keyboard or keypad), and/or a cursor control component 318 (e.g., mouse or trackball). In one embodiment, disk drive component 310 may comprise a database having one or more disk drive components.

Computer system 300 may perform specific operations by processor 304 executing one or more sequences of one or more instructions contained in system memory component 306, according to steps described above with respect to FIG. 1. Such instructions may be read into system memory component 306 from another computer readable medium, such as static storage component 308 or disk drive component 310. The various storage or memory components may be used to store the seller's shared secret. In other embodiments, hard-wired circuitry may be used in place of or in combination with software instructions to implement the invention.

Logic may be encoded in a computer readable medium, which may refer to any medium that participates in providing instructions to processor 304 for execution. Such a medium may take many forms, including but not limited to, non-volatile media, volatile media, and transmission media. In various implementations, non-volatile media includes optical or magnetic disks, such as disk drive component 310, volatile media includes dynamic memory, such as system memory component 306, and transmission media includes coaxial cables, copper wire, and fiber optics, including wires that comprise bus 302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various example embodiments, execution of instruction sequences for practicing embodiments of the invention may be performed by computer system 300. In various other embodiments, a plurality of computer systems 300 coupled by communication link 320 (e.g., network 110 of FIG. 1, LAN, WLAN, PTSN, or various other wired or wireless networks) may perform instruction sequences to practice the invention in coordination with one another.

Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

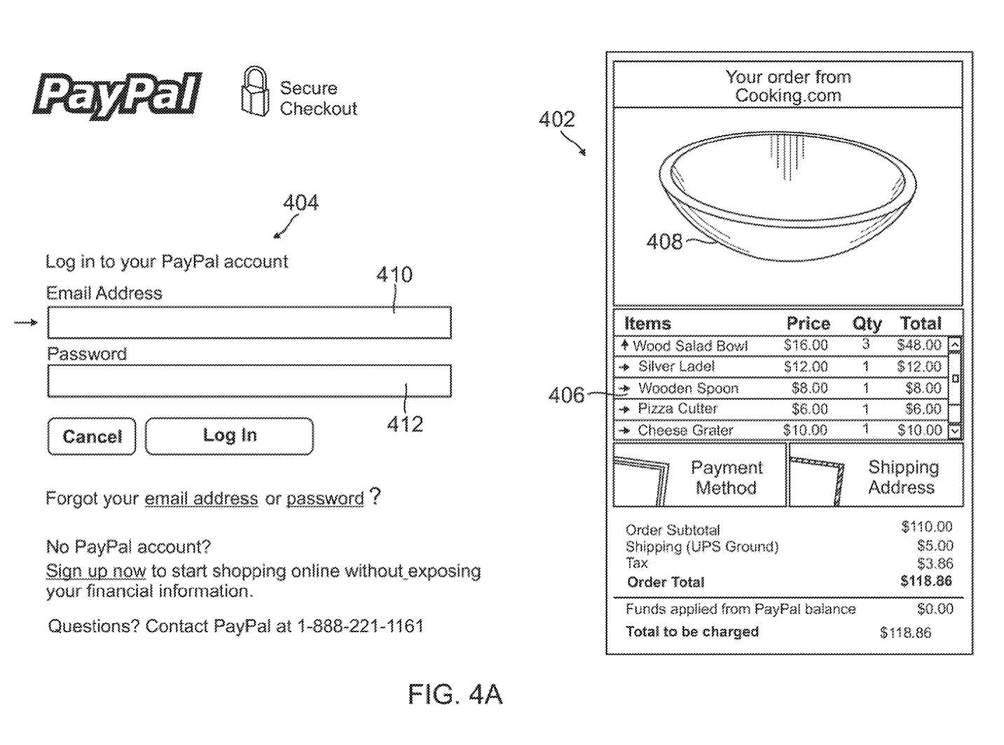

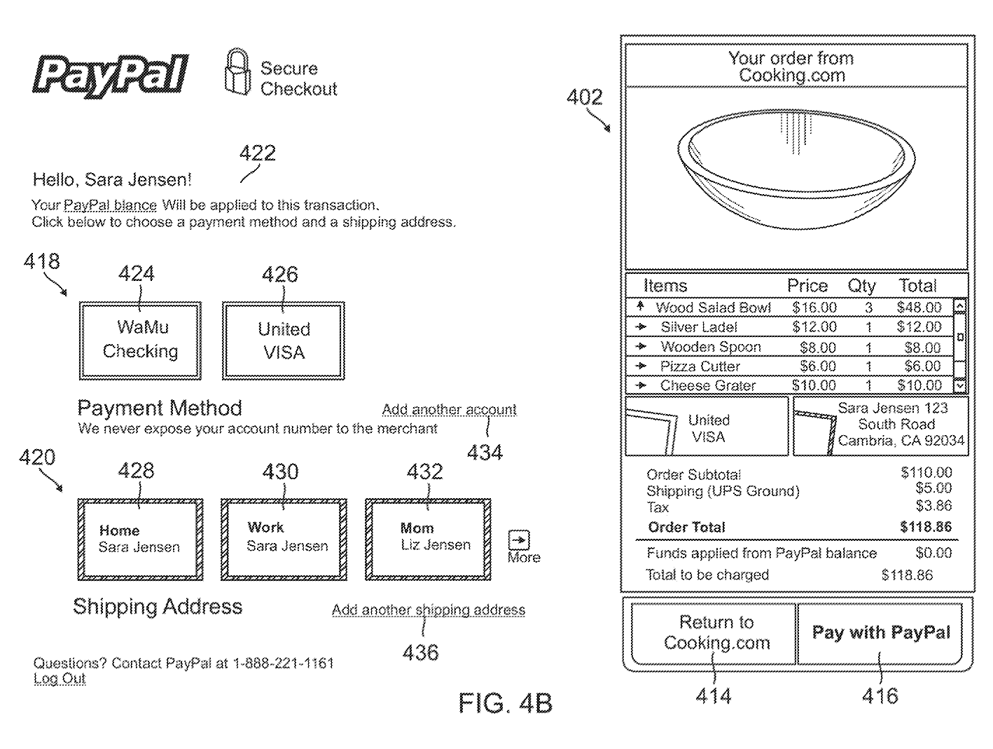

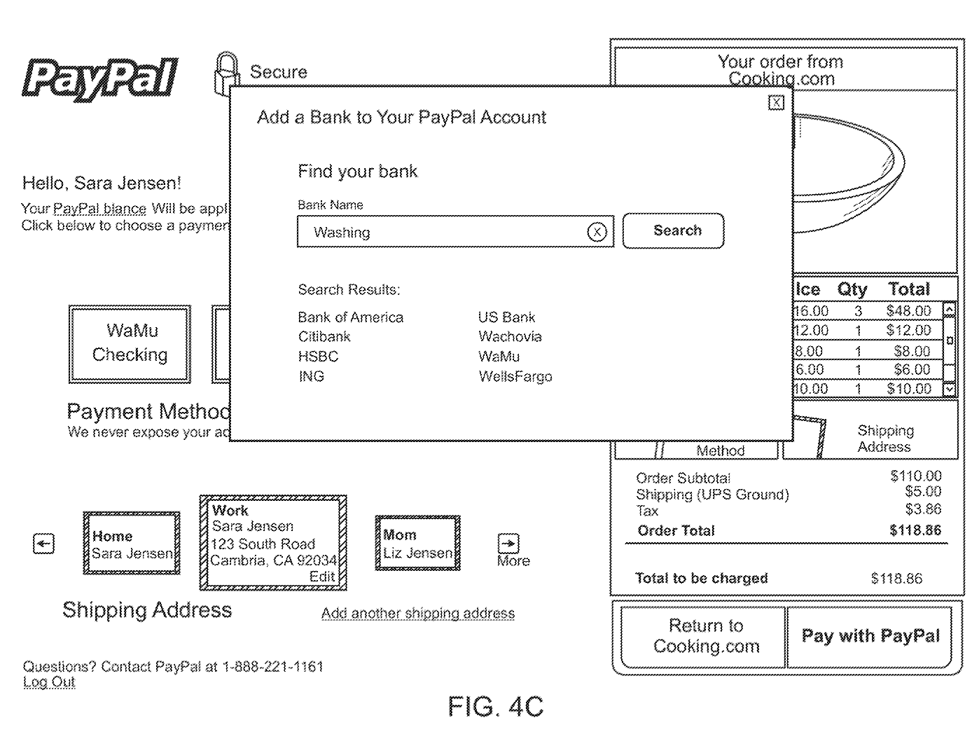

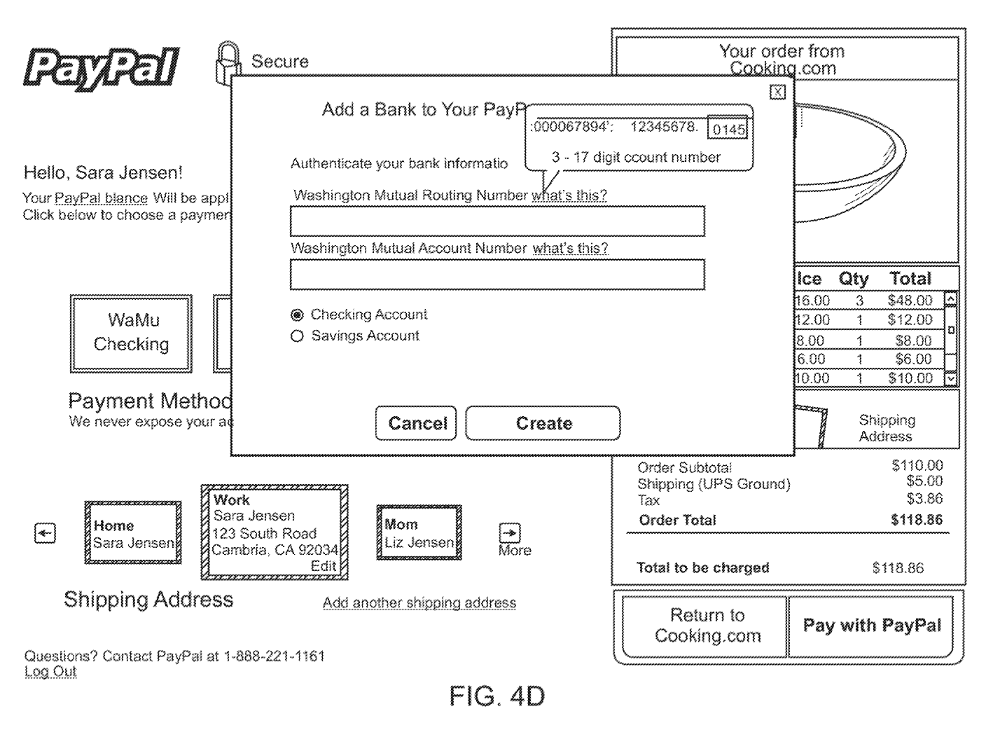

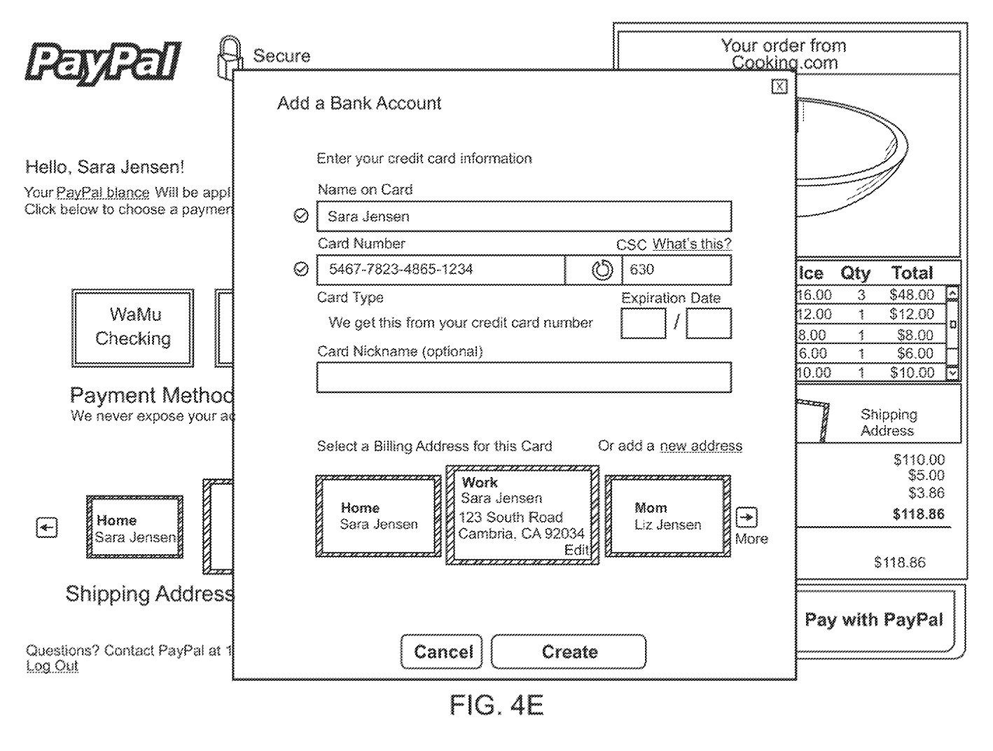

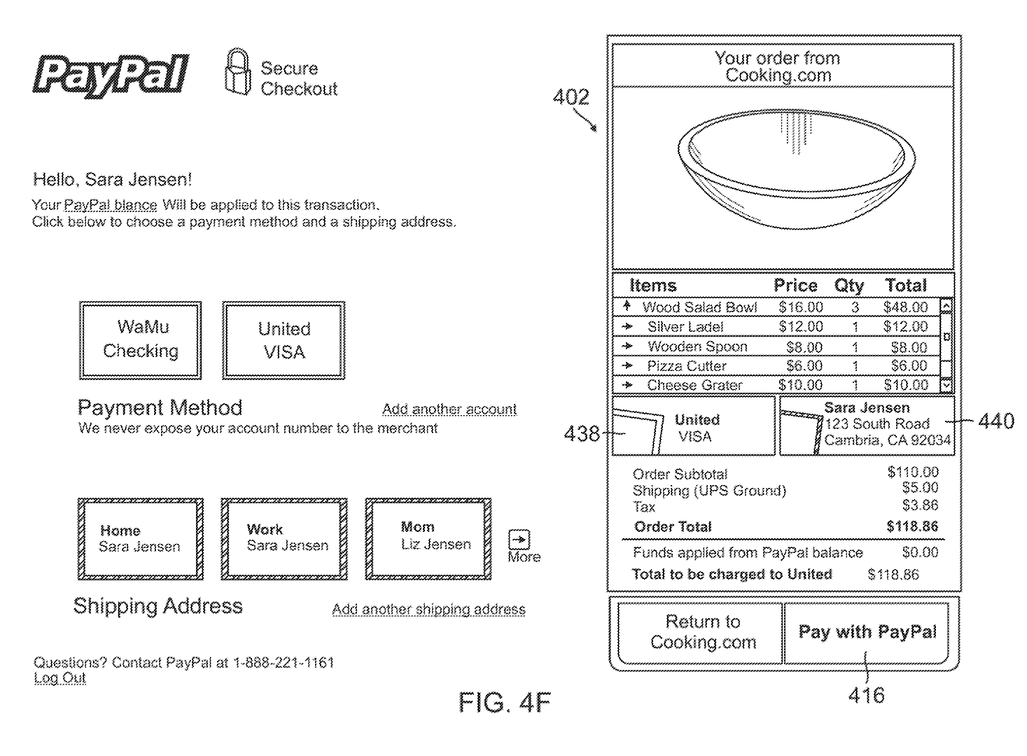

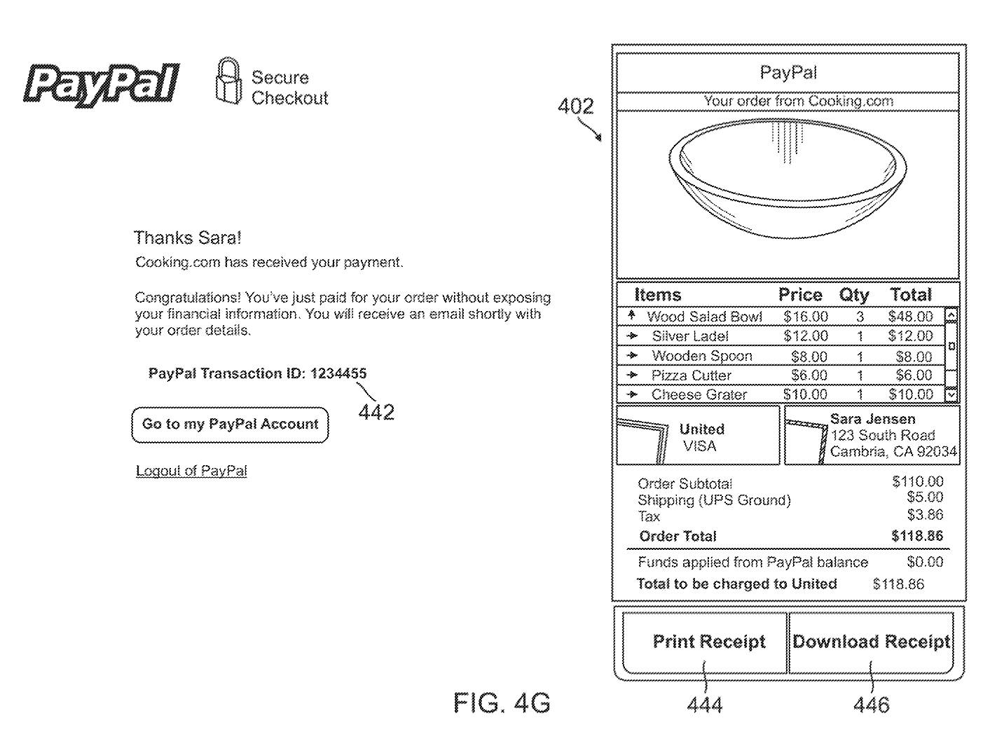

FIGS. 4A-4F are exemplary screen shots showing various pages presented to the user for an on-line checkout, according to one embodiment of the invention. FIG. 4A shows a screen that the customer sees after the customer has finished on-line shopping at the retailer or merchant site and is ready to checkout or pay for the items. In this example, the on-line retailer is Cooking.com. When finished shopping, the customer may click on a link to pay using the payment provider, such as PayPal. The customer is then presented with the screen shown in FIG. 4A, which includes a visual receipt 402 and a log-in portion 404 that shows fields for the customer to enter to log onto the customer's account. Visual receipt 402 includes a listing 406 of the items in the shopping cart to be purchased, as well as a visual representation 408 of one of the selected items from listing 406. Note that the payment method and shipping address portion of the visual receipt do not have information yet. Log-in portion 404 includes a field for the customer's email address 410 and a field for the password for the customer's account 412.

FIG. 4B shows a screen presented to the customer after the customer has successfully logged into his or her account. Visual receipt 402 now includes tabs to return to the on-line retailer 414 and to pay with the payment provider 416. The new screen also has shows the customer's name 418 and payment options 420 and shipping options 422 associated with the customer's account. Payment options 420 include different funding sources the customer can use to pay for the items in the visual receipt. In this example, funding sources include a checking account 424 and a credit card 426. Note that other funding sources may also be shown, such as additional checking accounts or credit cards, as well as on-line payment provider accounts and bank savings accounts. Shipping options 422 include icons for different shipping destinations used by the customer. In this example, shipping destinations include the customer's home 428, work 430, and mother 432. Any number or type of shipping destination may be part of the shipping options, such as friends and other relatives of the customer. Additional shipping addresses or payment options may be listed on a separate page as needed. The customer may also add payment options and shipping options by clicking on designated icons or links 434 and 436, respectively.

FIGS. 4C-4E show various screens presented to the customer when the customer wants to add a new payment option. FIGS. 4C and 4D are screens shown when the customer wants to add a bank savings or checking account. FIG. 4C shows a new screen overlaid on the previous screen. The new screen allows the customer to search for a bank or enter the bank's name. Once the desired bank is selected, another overlay screen is presented to the customer for entry of account specific information for the selected bank. In this example, a customer wants to add a checking account, which requires the customer to enter the routing number and account number. If the customer wants to add a savings account, the customer may be shown a field to enter the savings account number from the selected bank. Once the requested information has been entered, the customer can submit the information (such as by clicking on the “Create” button) to create and add the new bank funding source.

FIG. 4E shows a screen when the customer wants to add a new credit card account to the payment options. The overlaid screen shows fields requesting the user to enter the name on the card, the credit card number, the security code, and the expiration date. The customer is also given the option of providing a nickname for the card, such as “Sara's WaMu Visa.” The customer is also asked for the billing address of the credit card. This may be quickly and easily provided by simply clicking on a link to one of the shipping addresses associated with the user. If the credit card billing address is not one of those shipping addresses, the customer enters a new address for the billing address. Once all the requested information is entered, the customer submits the information (such as by clicking on the “Create” link) to create a new credit card payment option.

Adding new shipping options or addresses can be accomplished through similar screen shots. Once a new payment option or shipping option has been created, the user is presented a screen such as in FIG. 4B, but with the new shipping and/or payment option listed. Referring back to FIG. 4B, the customer can then click on a desired payment option or a desired shipping address. When the customer clicks on a desired funding source or shipping address, the screen refreshes to show that selection on the visual receipt.

FIG. 4F shows a screen shot where the customer has selected the United Visa credit card as the funding source or payment option and the customer's work address as the shipping address. Visual receipt 402 now shows at 438 the United Visa being the payment option and at 440 the customer's work address being the shipping address. The customer can change the payment option and/or the shipping option by simply clicking on another selection or adding a new account or shipping address. Also, at any time after logging into the payment provider account, the customer can go back to the on-line retailer to add, delete, or change the number of items in the visual receipt or shopping cart, such as by clicking on the “Return to Cooking.com” link 414. Once the customer is satisfied with the payment source and shipping address, the customer completes the process, such as by clicking on the “Pay with PayPal” link 416.

FIG. 4G shows a screen shot presented to the customer after payment and shipping information have been sent. The customer is notified that the payment has been sent and given a transaction ID 442. In addition to transaction ID 442, the customer is also provided additional options for confirmation of the payment. Visual receipt 402 may also include a print tab 444 and a download tab 446. Print tab 444 enables the customer to click on the tab to print out a copy of the receipt in a hard copy. Download tab 446 enables the customer to click on the tab to download a copy of the receipt to a specified destination, such as on the customer's computer.

Thus, using a single page on-line checkout, the customer can quickly and easily complete a purchase from an on-line retailer. Within the checkout page, the customer can view a dynamically changing visual receipt, which may include visual representations or pictures of items in listed on the visual receipt. The visual receipt also shows the customer-selected payment option and shipping address. Multiple payment and shipping options on the checkout page enable the customer to submit payment information easily and without entering sensitive financial information.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

Having thus described embodiments of the invention, persons of ordinary skill in the art will recognize that changes may be made in form and detail without departing from the scope of the invention. Thus, the invention is limited only by the claims.

What is claimed is:

1. A method for an on-line checkout, comprising:
receiving a notification that a user is ready to pay for items selected from an on-line site; and
presenting the user with a new screen for checkout, the new screen comprising:
a dynamic visual receipt;
one or more payment options; and
one or more shipping options.

2. The method of claim 1, further comprising refreshing the new screen to show a payment option within the visual receipt when the user selects the payment option.

3. The method of claim 1, further comprising refreshing the new screen to show a shipping option within the dynamic visual receipt when the user selects the shipping option.

4. The method of claim 1, wherein the dynamic visual receipt comprises a visual representation of one or more items listed on the visual receipt.

5. The method of claim 4, further comprising changing the visual representation when the user selects a different item on the visual receipt.

6. The method of claim 1, wherein the visual receipt comprises a list of the items selected from the on-line site, a selected payment option, and a selected shipping option.

7. The method of claim 1, wherein the payment options and the shipping options are shown as icons with text.

8. The method of claim 1, further comprising transmitting information corresponding to a payment option or a shipping option to the on-line site upon receiving an indication that the user has completed the checkout.

9. The method of claim 8, further comprising presenting the user with a second new screen, the second new screen comprising a modified visual receipt and a confirmation of payment.

10. The method of claim 9, wherein the confirmation comprises a transaction number.

11. The method of claim 9, wherein the-modified visual receipt comprises a link to download the visual receipt.

12. The method of claim 9, wherein the modified visual receipt comprises a link to print the visual receipt.

13. An on-line checkout page, comprising:
a visual receipt comprising:
a listing of items selected for purchase from an on-line site;
a first portion indicating a payment method;
a second portion indicating a shipping address; and
a visual representation of a selected one of the items, wherein the visual representation can be of different ones of the items;
one or more user-selectable payment methods; and
one or more user-selectable shipping addresses.

14. The checkout page of claim 13, wherein the visual receipt automatically changes to show a new payment method or shipping address when a payment method or a shipping address is selected by a user.

15. A method for an on-line, checkout of items selected from an on-line merchant site, the method comprising:
accessing a payment provider site; wherein the payment provider site comprises a visual receipt of the items, payment options, and shipping options;
selecting a payment option, which is automatically shown on the visual receipt;
selecting a shipping option, which is automatically shown on the visual receipt; and
submitting the payment option and shipping option to the on-line merchant site.

16. The method of claim 15, further comprising selecting one of the items for display as a visual representation on the visual receipt.

17. The method of claim 15, further comprising adding additional payment or shipping options to the payment provider site.

18. The method of claim 15, wherein the selecting comprises clicking on a link or icon.

19. The method of claim 15, wherein the submitting comprises clicking on an icon or a link attached to the visual receipt.

20. The method of claim 15, further comprising downloading the visual receipt after the submitting.

21. The method of claim 15, further comprising printing the visual receipt after the submitting.
